(19) United States
(12) Patent Application Publication
(10) Pub. No.: US 2013/0144634 A1
(43) Pub. Date: Jun. 6, 2013

(54) METHOD OF TRACKING AND RETRIEVING PERSONALTY

(71) Applicant: CONRAD REYNOLDS, Conway, AR (US)

(72) Inventor: CONRAD REYNOLDS, Conway, AR (US)

(21) Appl. No.: 13/309,652

(22) Filed: Dec. 2, 2011

(51) Int. Cl. G06Q 99/00

(52) U.S. Cl. 705/1.1

(57) ABSTRACT

A system for the tracking and recovery of personal property, including the establishment of a system administrator and the establishment of a business relationship between said system administrator and a client. The system administrator providing to the client in exchange for a fee, a dedicated code, along with a toll free telephone number and a web address to permit a finder of the lost property to communicate its finding to the system administrator. The system administrator then providing instructions for the recovery of the property to the finder, resulting in the ultimate return of the property to the client without ever disclosing any personal information regarding the client or the finder.

The present invention relates, in a general sense, to lost, stolen or purloined property, and, more particularly, to the tracking and retrieval of personal property, and ultimately the return of such property to its rightful owner.

### BACKGROUND OF THE INVENTION

1. Field of the Invention

The essence of personal property is that it is transitory. It is mobile and, to many, from time to time, too mobile. In one moment, its location is well known, and, for some inexplicable reason, it can not be found. The person who has not lost, misplaced, or otherwise finds him/herself unable to find an item of personal property, is rare indeed. The problem is exacerbated when the loss occurs at a location or area remote form one's home base.

For example, an item of personal property may have turned up missing at a location so remote as to be impossible, or at least impractical, to return to search for it. Then what is a person to do? It is to that quandary that the present invention has particular, although not exclusive, utility.

2. Overview of the Related Art

It is evident from the art this is not the first person to attack the articulated problem . . . just perhaps the best. For example, Feld publication 2008/0035722 (now abandoned) provides a label system to assist in the return of lost articles. The claims talk of a device for providing easy return to a user of an electronic item which features tags having adhesive to be placed on items of personal property.

Frankel et al. patent 6,449,611 discusses a business model for the recovery of missing goods. Both patents use computers, as does the present invention. Neither of the patents discussed anticipates, nor renders obvious, the present invention. There are several other devices for the retrieval of personal property, all of which fall short of the present invention and, from a market standpoint, none seem to have captured the imagination of the public. It will become evident that the shortcomings of the prior art are overcome by the present invention.

### SUMMARY OF THE INVENTION

The present invention teaches a simple, yet practical, system for the location and retrieval of personal property. Keeping with that theme, it is a principal objective of the present invention to provide a straight forward, yet efficient, program for the effective tracking and recovery of personal property that has been misplaced, lost or stolen.

Another objective of the present invention is to provide a method of retrieving personal property which is universal in its application, and planet wide in its scope. A further objective of the present invention is to inhibit theft by notifying the thief in advance of the security system surrounding the object of his or her temptation.

Yet Another objective of the invention is to accomplish all of its objectives while maintaining the privacy, and, indeed, the identity, of the owner of the missing and found property.

The foregoing, together with other objects and advantages of the present invention will become evident to those skilled in the art when the Detailed Description of a Preferred Embodiment is studied in concert with the accompanying drawings, wherein:

### DESCRIPTION OF THE DRAWING

FIG. 1 is a schematic representation of the method of the present invention, illustrating the line of communication in accordance with that method; and,

FIG. 2 is an enlarged pictorial representation of a proposed information label to be placed on items of personal property.

### DETAILED DESCRIPTION OF A PREFERRED EMBODIMENT

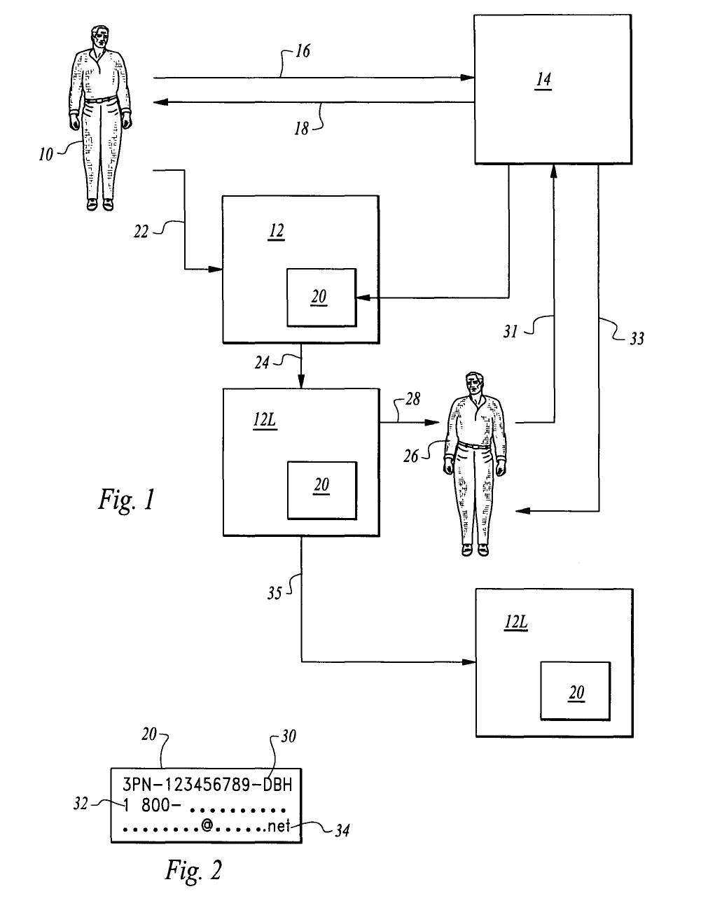

With reference now to the FIG. 1 schematic, a client 10 is possessed of various items of personal property which he wishes to protect within the system created by the present invention.

The client 10 makes application to a previously established office of a system administrator, manned by a system administrator 14 of the system in any number of convenient, but confidential communication of information 16, such as telephone, email and, where possible, in person. Upon payment of a fee and providing some personal information, e.g., home address and phone number, the system administrators office 14 accesses a computer program, developed expressly to implement the system of the present invention, which provides unique and random codes, and the system administrators office 14 then conveys to client 10, by any suitable means 18, that code, together with the administrator's office appropriate communication vehicle, i.e., dedicated telephone number and discrete website address. The use of the code system is intended to protect the client's personal information, and the client him/herself from harassment from sales people, identity thieves and others.

Having thus established a business relationship with the system, the client then proceeds to impress upon his personal property a label 20, which is created by, or for, him with information provided by the system administrator's office 14. That label 20 includes a unique and dedicated alpha-numeric code 30 attributable only to the property owner as the client 10, together with the phone number and email address provided by the system administrator's office 14, which has been provided to the client. See FIG. 2, wherein the number for the top line reflects the code 30 generated by the computer for each client. As formulated, the code 30 contains 16 elements, the first of which will always be 3PN, followed by 13 integers, or a combination of integers and letters, at the discretion of the system administrator. That code 30 identifies, confidentially to the administrator, the client 10 without disclosing to anybody, including the system administrator 14, any personal information regarding the client 10, thereby protecting his/her identify from theft. The next line provides a toll free telephone number 32, which would permit a citizen 26 to contact the system administrator's office to inform him/her that he has found the previously lost personal property 12L. A third line provides a web address 34 which would also permit citizen 26 to access the system administrator's office 14 via the Internet to inform the system administrator of the finding of the personal property by citizen 26.

Any number of methods may be used to apply the label 20, including, but not limited to, etching, Dymo-type labels and a paper or metallic label having the information impressed thereon. It is preferable that whatever method is chosen to secure the label to the property, it should be as permanent as the personal property reasonably allows, in order that it can not be readily removed without great difficulty and even, perhaps, partial destruction of the label itself.

In the envisioned scenario, which is the essence of the present invention, the property 12 becomes misplaced, or otherwise lost at 12L, as reflected by the communication arrow 24. Fortuitously, the personal property is found by citizen 26, via communication arrow 28. Citizen 26, being a good citizen, notices the label 20 on the personal property 12L and communicates with the system administrator 14 via communication vehicle arrow 31.

In accordance with the invention, the system administrators office 14, having secured the code on the property, inserts the code into its computer program in order to identify the owner, client 10. The system administrator 14, via communication arrow 33, notifies citizen 26 that it has identified the client 10, but does not provide citizen 26 with any of the information respecting client 10, thereby assuring that client 10's identity and personal information remains confidential. The system administrator 14, via communication arrow 33, instructs citizen 26 to secure the found personal property 12L at a particular location via communication arrow 35 and, where authorized by client 10, informs citizen 26 that upon securing the property at the identified location, a reward to citizen 26 may, or will be, forthcoming.

There are instances, albeit rare, where the finder, or a third party, has a legitimate reason to request the identity of the property owner. The police, e.g., or other governmental authority might be such a third party. Where such an instance has legitimately risen, the system of the present invention provides an avenue for addressing such an occurrence.

Upon application to the office of the system administrator, the system administrator will evaluate the application, and, upon good cause having been shown, the system administrator shall grant the applicant access to the virtual vault created within the computer program. In that vault is, or are, pieces of information, e.g., the last four digits of a social security number or driver's license, or some other clue to the identity of the product's owner, thus satisfying the request.

In summary, while the present system does not guarantee that an item of lost personal property will be found, it, nonetheless, assures the owner of lost personal property that, if found, an easy and convenient means of tracking and recovering that lost property is available to the finder, at little or no expense to him or her, and accomplishes this objective without disclosure of any information regarding the original owner thereof.

Those skilled in the art will perceive the existence of additional variations in the recited method. It will be understood that such variations are within the scope of the following claims, wherein:

1. A system for the tracking and restoring of lost personal property to its rightful owner, comprising the steps of:
(a) creating an office of the system administrator;
(b) establishing a business relationship between said office of the system administrator and said rightful owner as a client in which said client provides the office of said system administrator, for a fee and communication information unique to said client, said office of system administrator, in return, providing for said client a code unique to said client, together with a communication vehicle, said client code constructed to conceal the identity of said client;
(c) said code and communication vehicle being applied to a label, said label being affixed to items of personal property belonging to said client;
(d) upon loss of said personal property, a finder of said personal property accessing said system administrator to inform said system administrator of the finding of said personal property; said office of system administrator providing said finder with instructions as to the disposition of said personal property; and said finder following said instructions to effect the ultimate return of said personal property to said client.

2. The system of claim 1, wherein said communication vehicle is a unique, toll free telephone number from which said finder is able to communicate with the office of said system administrator his or her finding.

3. The system of claim 1, wherein said communication vehicle is a web address from which said finder is able to communicate with the office of said system administrator his or her finding.

4. The system of claim 2, wherein said communication vehicle additionally includes a web address from which said finder is able to communicate with the office of said system administrator his or her finding.

5. The system of claim 1, wherein said communications with said system administrator's office maintains all information on the said client and said finder in confidence.

6. A system for the tracking and restoring of lost personal property to its rightful owner, comprising the steps of:
(a) creating an office of the system administrator;
(b) establishing a business relationship between said office of the system administrator and said rightful owner as a client in which said client provides the office of said system administrator, for a fee and communication information unique to said client, said office of system administrator, in return, providing for said client a code unique to said client, together with a communication vehicle, said client code constructed to conceal the identity of said client;
(c) establishing a virtual vault for the electronic storage of said client's identity and said communication information;
(d) said code and communication vehicle being applied to a label, said label being affixed to items of personal property belonging to said client;
(e) upon loss of said personal property, a finder of said personal property accessing said system administrator to inform said system administrator of the finding of said personal property; said office of system administrator providing said finder with instructions as to the disposition of said personal property; and said finder following said instructions to effect the ultimate return of said personal property to said client;
(f) permitting the receipt by said system administrator of communications for disclosure of said client's identity, said system administrator evaluating said application and, upon approval thereof, providing said applicant with requested information from said virtual vault.

7. The system of claim 6, wherein said communication vehicle is a unique, toll free telephone number from which said finder is able to communicate with the office of said system administrator his or her finding.

8. The system of claim 6, wherein said communication vehicle is a web address from which said finder is able to communicate with the office of said system administrator his or her finding.

9. The system of claim 6, wherein said communication vehicle additionally includes a web address from which said finder is able to communicate with the office of said system administrator his or her finding.
